(19) United States
(12) Patent Application Publication
(10) Pub. No.: US 2023/0082374 A1
(43) Pub. Date: Mar. 16, 2023

(54) PREDICTION OF DEWAR FAILURE

(71) Applicant: Cryoport, Inc., Brentwood, TN (US)

(72) Inventors: Amir Vahid, Brentwood, TN (US); Bret Bollinger, Yorba Linda, CA (US); Phil Schlesinger, Brentwood, TN (US); Chris Exline, Brentwood, TN (US); Ashish Misra, Brentwood, TN (US)

(73) Assignee: Cryoport, Inc., Brentwood, TN (US)

(21) Appl. No.: 17/477,381

(22) Filed: Sep. 16, 2021

(51) Int. Cl. F17C 3/08; G06Q 10/08; G06N 5/00

(52) U.S. Cl. CPC F17C 3/085; G06Q 10/0832; G06N 5/003; F17C 2223/0161; F17C 2270/0509; F17C 2203/0391; F17C 2203/0629

(57) ABSTRACT

Method, system, apparatus, and/or device for predicting the failure of a shipper. The failure prediction system includes a first sensor configured to detect or measure first sensor data. The failure prediction system includes a memory configured to store a dewar failure model that models a failure of various shippers given one or more constraints. The failure prediction system includes a processor coupled to the memory and the first sensor. The processor is configured to estimate or predict a probability or a likelihood that a shipper will fail before or during a subsequent shipment of the shipper based on the first sensor data and the dewar failure model. The processor is configured to provide the estimated probability or likelihood that the shipper will fail before or during the subsequent shipment of the shipper.

### BACKGROUND

### 1. Field

This invention relates to a system, device or apparatus that predicts when a dewar may fail.

### 2. Description of the Related Art

In the shipping business, certain types of contents and cargo require extra special care. This need is apparent when shipping biological samples and specimens. Businesses, hospitals, labs and other research or consumer facilities need to ship biological material that is highly susceptible to cellular degradation if not kept at a certain temperature and require cryogenic shipping services to ship biological material at cryogenic temperatures (approximately −150 degrees Celsius). The shipping of these temperature controlled materials requires special equipment, such as a dry vapor shipper that is validated to maintain the cryogenic temperature for an extended period to prevent or avoid cell degradation or loss. For example, a dry vapor shipper is a metallic flask that has a payload area or well that holds the biological material at cryogenic temperatures for a long period of time to allow the transport of the biological material.

The biological material that is shipped in these shippers are of high value due to the cost and their “life-saving” nature. The failure of the shipper may cause degradation or other damage of the biological material that is being transported, which may result in the loss of life when a patient needs the biological material that is being transported for treatment. Accordingly, when the dry vapor shipper is returned, the dry vapor shipper's functionality must be verified prior to shipment of the next payload to prevent failure of the shipper during the transport. The standard procedure involves evaluating the dynamic hold time of the shipper and determining whether the shipped may need to be retired.

The current process of evaluating the dynamic hold time to determine whether the shipper needs to be retired, however, does not consider various other factors that may impact the failure of the shipper. And thus, the current process may not adequately identify shippers that may fail during the next shipment but rather only identifies shippers that may no longer meet a minimum holding time requirement as the shipper may fail for various different other reasons. Since the shipper may fail in multiple ways including poor thermal performance, catastrophic failure and/or failure due to mishandling, merely measuring the dynamic hold time does not account for these other types of failures. For example, the shipper may fail due to poor thermal performance over time, due to age, abuse, loss of vacuum or other reasons, and the shipper may slowly lose its thermal characteristics and become thermally inefficient. In another example, the shipper may fail due to catastrophic failure, which is usually due to shock causing the shipper to form a breach in the walls of the shipper, which may cause the loss of the vacuum. And, in another example, the shipper may fail due to mishandling, such as when the shipper is placed on its side or upside down, which may cause the evaporation rate to increase and causes a temporary reduction in the dynamic holding time for the current trip.

Accordingly, there is a need for a method, system, device or apparatus to improve prediction of the failure of a dry vapor shipper to better anticipate when a dry vapor shipper may fail.

### SUMMARY

In general, one aspect of the subject matter described in this specification is embodied in a failure prediction system. The failure prediction system includes a first sensor configured to detect or measure first sensor data. The failure prediction system includes a memory configured to store a dewar failure model that models a failure of various shippers given one or more constraints. The failure prediction system includes a processor coupled to the memory and the first sensor. The processor is configured to estimate or predict a probability or a likelihood that a shipper will fail before, during or during a subsequent shipment of the shipper based on the first sensor data and the dewar failure model. The processor is configured to provide the estimated probability or likelihood that the shipper will fail before, during or after the subsequent shipment of the shipper.

These and other embodiments may optionally include one or more of the following features. The failure prediction system may include a display. The display may be configured to output the estimated probability or likelihood that the shipper will fail before, during or after the subsequent shipment of the shipper. The failure prediction system may include a user interface. The user interface may be configured to receive user input that indicates whether the shipper failed before, during or after the subsequent shipment of the shipper. The processor may be configured to update the dewar failure model based on the user input and the sensor data in real-time.

The sensor may include at least one of a temperature sensor, a shock or vibration sensor, or a pressure sensor. The sensor data may include at least one of a temperature within the shipper, shocks or vibrations to the shipper or a pressure within the shipper. The processor may be further configured to estimate or predict the probability or the likelihood that the shipper will fail before, during or after a subsequent shipment of the shipper using a machine learning algorithm. The machine learning algorithm may be a boosted decision tree algorithm.

In order to estimate or predict the probability or the likelihood that the shipper will fail before, during or after the subsequent shipment of the shipper, the processor may be configured to estimate or predict a probability or a likelihood that a dynamic holding time of the shipper is less than a threshold amount. The failure prediction system may include a second sensor. The second sensor may be configured to measure or detect second sensor data, wherein the first sensor is a temperature sensor and the first sensor data is a temperature within the shipper and the second sensor is a pressure sensor and the second sensor data is a pressure within the shipper.

The processor may be configured to obtain user input that indicates a type, model or identifier of the shipper. The processor may be configured to obtain maintenance information related to the type, model or the identifier of the shipper. The processor may be configured to estimate or predict the probability or the likelihood that the shipper will fail before, during or after the subsequent shipment of the shipper further based on the maintenance information and the user input. The maintenance information may include a number of thermal or temperature cycles that the shipper has undergone.

In another aspect, the subject matter is embodied in a failure prediction system. The failure prediction system includes a processor. The processor is configured to obtain at least one of maintenance information or sensor data. The processor is configured to estimate or predict a probability or a likelihood that a shipper will fail before, during or after a subsequent shipment of the shipper based on the at least one of the maintenance information or the sensor data and using a machine learning algorithm. The processor is configured to provide to a user the estimated probability or likelihood that the shipper will fail before or during the subsequent shipment of the shipper. The failure prediction system includes a display. The display is configured to output to the user the estimated probability or likelihood that the shipper will fail before, during or after the subsequent shipment of the shipper.

In another aspect, the subject matter is embodied in a method for predicting failure of a shipper. The method includes obtaining, by a processor, a dewar failure model that models a failure of various shippers. The method includes detecting or measuring, by a sensor, sensor data that relates to a failure of the shipper. The method includes estimating or predicting, by the processor, a probability or a likelihood that the shipper will fail before, during or after a subsequent shipment of the shipper based on the sensor data and the dewar failure model. The method includes displaying, by the processor and on a display, the estimated probability or likelihood that the shipper will fail before, during or after the subsequent shipment of the shipper.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale and may be exaggerated to better illustrate the important features of the present invention.

FIG. 1 shows an example of a dewar failure prediction system according to an aspect of the invention.

FIG. 2 is a flow diagram of an example process for estimating or predicting a probability or a likelihood of a shipper failure using the dewar failure prediction system of FIG. 1 according to an aspect of the invention.

FIG. 3 is a flow diagram of an example process for generating and updating the dewar failure model using the dewar failure prediction system of FIG. 1 according to an aspect of the invention.

FIG. 4 shows a diagram that summarizes the flow of data among the components of the dewar failure prediction system of FIG. 1 according to an aspect of the invention.

### DETAILED DESCRIPTION

Disclosed herein are systems, apparatuses and devices for a dewar failure prediction system. The dewar failure prediction system (or “failure prediction system”) uses machine learning algorithms to predict the failure of a dry vapor shipper (or “shipper”), such as a dewar. The machine learning algorithms may utilize a dewar failure model to predict the failure of the shipper. The dewar failure model may use sensor data, maintenance data, historical/sample shipper data, statistical data and/or other data that relates to the specific shipper to more accurately predict when the specific shipper will fail in comparison to solely relying on a single parameter, such as the static/dynamic holding time, to determine when the shipper will fail. By using machine learning algorithms and tailored information related to the specific shipper, the failure prediction system more accurately estimates and predicts the likelihood or probability that the shipper will fail during the next shipment.

Other benefits and advantages include obtaining various types of data from various sources to improve the accuracy of the prediction of the dewar failure. The failure prediction system may aggregate, collect or otherwise obtain sensor data, maintenance data, historical/sample shipper data and other forms of data (hereinafter, referred to as “monitored data”) that are related to and/or contribute to the failure of a dry vapor shipper (or “shipper”), such as a dewar, from multiple sources. The failure prediction system 100 may aggregate, collect or otherwise obtain the monitored data over a period of time and aggregate, collect or otherwise obtain the resulting failure or non-failure of the shipper on the subsequent shipment to build an accumulated knowledge-base to estimate and predict the probability or likelihood of failure of the shipper before, during or after a subsequent shipment. Since the failure prediction system uses various forms of monitored data from multiple sources over a long period of time, the failure prediction system may more accurately predict or estimate the likelihood or probability of the failure of the shipper.

Additionally, the failure prediction system continues to learn and update the dewar failure model in real-time. The failure prediction system feeds the output that results from the one or more constraints or inputs back into the dewar failure model, which causes the dewar failure model to learn and be updated in real-time. Since the dewar failure model is updated in real-time, the failure prediction system is more accurately able to predict or estimate the likelihood or probability of failure of a shipper for a subsequent shipment.

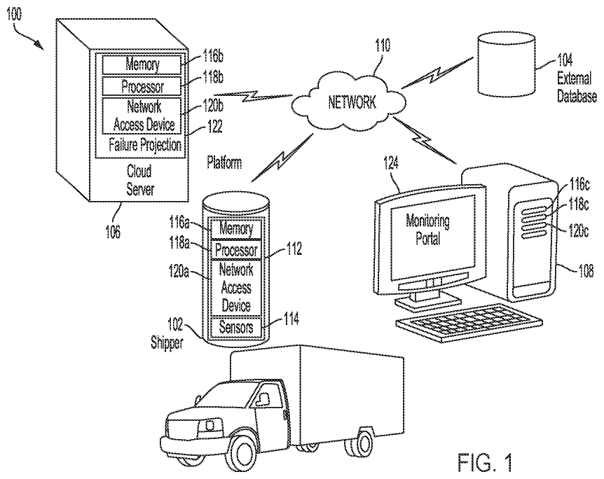

FIG. 1 shows the dewar failure prediction system (“failure prediction system”) 100. The failure prediction system 100 includes the shipper 102, the external database 104 and/or one or more computing devices, such as the local, remote or cloud server (hereinafter, referred to as “server”) 106 and/or a monitoring portal 108. The failure prediction system 100 may have a network 110 or be connected to a network 110 that links or provides communication and/or data transfer amongst the shipper 102, the external database 104 and/or the one or more computing devices. The network 110 may be a local area network (LAN), a wide area network (WAN), a cellular network, a network cloud, the Internet, or combination thereof, that connects, couples and/or otherwise communicates between the various components of the failure prediction system 100, such as the one or more computing devices, the external database 104 and/or the shipper 102.

The failure prediction system 100 includes a dry vapor shipper (or “shipper”) 102. The shipper 102 is a vacuum insulated container that is used to transport material, such as biological material, at a cryogenic temperature. The shipper 102 may be a dewar. The dewar may be a double-walled flask that has an inner wall and an outer wall. A vacuum may be formed in between the inner wall and the outer wall to hold, insulate or store a liquid or gas below ambient temperatures. The inner wall of the inner vessel may have an absorbent material, such as a liquid or a gas. The dewar may have an opening that receives a vapor plug, which may be used to partially seal the opening of the dewar. The opening leads to a cavity or payload area that is within the dewar that holds the commodity, such as the biological material, within the dewar.

A vapor plug may act like a cork to partially seal an opening of the dewar. The vapor plug partially seals the opening to allow the liquid or gas to escape so that pressure does not build up inside the dewar and cause an explosion. As the gas or liquid escapes, warm air is drawn into the dewar, which may cause further evaporation of the gas or liquid.

The shipper 102 may include or be coupled to a monitoring device 112. The monitoring device 112 monitors the status and/or condition of the shipper 102 as the shipper 102 transits from a shipment location to a destination location. The monitoring device 112 may include one or more sensors 114 that detect, measure, monitor and/or otherwise determine or obtain the sensor data that relates to the status and/or condition of the shipper 102. The status and/or the condition of the shipper 102 may include the temperature and/or the change in the temperature within the shipper 102, the pressure and/or the change in the pressure within the shipper 102, the location and/or orientation of the shipper 102, shocks or vibrations to the shipper 102 during transit or storage, duration or distance of the shipment and/or other information. The other information may include a measurement of a static or dynamic holding time, nitrogen evaporation rate (NER), LN2 capacity, number of thermal cycles, re-pumping, heat conduction altitude, humidity or any physical damage. For example, the one or more sensors 114 may include a temperature sensor, a pressure sensor, an accelerometer or gyroscope, a shock or vibration sensor and/or a global positioning system (GPS) device.

A temperature sensor, such as a thermocouple device, may measure the temperature and/or the change in the temperature within the shipper 102. A pressure sensor may measure the pressure and/or the change in the pressure within the shipper 102. A shock or vibration sensor may measure when there is an impact to the shipper 102, and/or a GPS device may detect or determine the location of the shipper 102 and the duration or distance travelled. The accelerometer or gyroscope may detect the orientation, direction of travel or acceleration of the shipper 102.

The monitoring device 112 includes a memory 116a, a processor 118a and/or a network access device 120a. The memory 116a may store the sensor data collected by the one or more sensors 114 during transit of the shipper 102 so that the sensor data may be provided to the other components of the failure prediction system 100, such as the server 106 and/or the monitoring portal 108. The sensor data may include the temperature, the pressure, and/or the shock or vibration events along the route that the shipper 102 transits. The sensor data may be stored to be uploaded before, after or during the shipment of the shipper 102 to a destination location. The processor 118a executes instructions stored within the memory 116a to use the one or more sensors 114 to detect, measure and/or obtain sensor data and provide the sensor data into the failure prediction platform 122 to facilitate prediction of the failure of the shipper 102. The network access device 120a may be used to communicate with the other components, such as the monitoring portal 108 and/or the server 106.

The failure prediction system 100 may have an external database 104, which may be associated with a service provider. A service provider may provide information to the failure prediction platform 122. The information may include data sets of the historical/sample shipper data. The historical/sample shipper data may include sensor data collected from multiple shippers over multiple shipments over the lifetime of the multiple shippers or other experimental or testing data. The sensor data may be related to the status and/or condition of the multiple shippers over the multiple shipments. The historical/sample shipper data may include the status and/or condition of each of the multiple types or kinds of shippers when the shippers subsequently failed and the status and/or condition of each of the multiple types or kinds of shippers when the shippers did not fail during shipment. The historical/sample shipper data may include an association between the status and/or condition of the multiple shippers and the specific type or kinds of shippers. The historical/sample shipper data may also include the routes, the number of routes, the maintenance performed, and/or other additional data related to the status and/or condition of each of the multiple shippers over the multiple shipments.

A database is any collection of pieces of information that is organized for search and retrieval, such as by a computer, and the database may be organized in tables, schemas, queries, report, or any other data structures. A database may use any number of database management systems. The one or more external databases 104 may include a third-party server or website that stores or provides the meeting information. The information may be real-time information, updated periodically, or user-inputted. A server may be a computer in a network that is used to provide services, such as accessing files or sharing peripherals, to other computers in the network. A website may be a collection of one or more resources associated with a domain name.

The failure prediction system 100 includes one or more computing devices, such as a server 106 and/or a monitoring portal 108. The server 106 may include a failure prediction platform 122. The failure prediction platform 122 estimates or predicts the probability or likelihood of the potential failure of a shipper 102. The potential failure of the shipper 102 refers to whether a shipper 102 will fail before, during or after a subsequent shipment of the shipper but prior to the following shipment after the subsequent shipment. The failure prediction platform 122 may predict the potential failure for various shippers of different types, kinds and/or models. The failure prediction platform 122 may use a machine learning algorithm, such as a boosted decision tree algorithm, to estimate or predict the probability or the likelihood of the potential failure of the shipper 102.

The failure prediction platform 122 may include a memory 116b, a processor 118b and/or a network access device 120b. The memory 116b may store sensor data, historical/sample shipper data, maintenance data and/or other data, which may affect the lifespan, durability and/or potential failure of various shippers. The memory 116b may store one or more constraints, which may indicate a limit to one or more types of data and/or their corresponding weighting used when the failure prediction platform 122 models the potential shipper failure using a dewar failure model. The memory 116b may store a dewar failure model that models the potential failure of various shippers that may have resulted from the aggregated or collected data related to the shipper and/or based on the one or more constraints. The processor 118b may be coupled to the memory 116b and execute or apply instructions stored in the memory 116b to estimate or predict the potential failure of the shipper. The network access device 120b communicates with the other components, such as the monitoring portal 108 and/or the shipper 102, to receive the sensor data and/or the maintenance information and to provide the estimated or predicted probability or likelihood that the shipper 102 will fail.

The failure prediction system 100 may include a monitoring portal 108. The monitoring portal 108 may be implemented on a personal device, such as a personal computer, laptop, tablet or other personal device. The monitoring portal 108 may include a memory 116c, a processor 118c and a network access device 120c. The memory 116c may store the sensor data, the historical/sample shipper data, the maintenance data and/or the other data, which may affect the lifespan, durability and/or potential failure of various shippers. For example, the sensor data, the maintenance data and/or the other data may be captured by the monitoring portal 108 in real-time from the one or more sensors 114 on the shipper 102. The captured data may be displayed on a display to allow a user to monitor the data in real-time as the shipper 102 transits during shipment. Moreover, the monitoring portal 108 may store maintenance data, such as the number of thermal cycles that the shipper 102 has undergone, the age of the shipper 102, the number of miles that the shipper 102 has travelled and/or previous estimations or predictions of the potential shipper failure, which may be continued to be monitored, recorded, updated and displayed to facilitate the determination, estimation or prediction of a potential shipper failure. The processor 118c may be coupled to the memory 116c and execute or apply instructions stored in the memory 116c. The processor 118c may collect the sensor data, the historical/sample shipper data, the maintenance data and/or the other data and may render, on the display, one or more graphical representations that display the sensor data, the historical/sample shipper data, the maintenance data and/or the other data over a period of time. The processor 118c may obtain the estimated or predicted probability or likelihood that the shipper 102 will fail and display the estimated or predicted probability or likelihood to a user. The network access device 120c communicates with the other components, such as the shipper 102 or the server 106, to receive the sensor data and/or the maintenance information and/or to receive the estimated or predicted probability or likelihood that the shipper 102 will fail.

The monitoring portal 108 may include a user interface 124. The user interface 124 provides an interface to a user to receive user input, such as maintenance information, one or more constraints and/or other information. The user interface 124 also provides an interface to display information to the user, such as the estimated or predicted probability or likelihood that the shipper 102 will fail and/or the sensor data or other data related to the failure of the shipper 102. The user interface 124 may include an input/output device that receives user input from a user interface element, a button, a dial, a microphone, a keyboard, or a touch screen. For example, the user interface 124 may receive user input that may include maintenance information, such as the age of the shipper 102, the number of thermal cycles that the shipper 102 has undergone or other data related to the potential failure of the shipper. The other data may also include observations made by the user, such as any damage that is noticeable to the shipper 102. The user interface 120 may provide an output to an output device, such as a display, a speaker, an audio and/or visual indicator, or a refreshable braille display. For example, the monitoring portal 108 may render a graphical representation of the collected data on a display.

The one or more processors 118a-c may each be implemented as a single processor or as multiple processors. The one or more processors 118a-c may be electrically coupled to, connected to or otherwise in communication with the corresponding memory 116a-c, the network access devices 120a-c and/or user interface 124.

The one or more memories 116a-c may be coupled to the one or more processors 118a-c and store instructions that the processors 118a-c execute. The one or more memories 116a-c may include one or more of a Random Access Memory (RAM) or other volatile or non-volatile memory. The one or more memories 116a-c may be a non-transitory memory or a data storage device, such as a hard disk drive, a solid-state disk drive, a hybrid disk drive, or other appropriate data storage, and may further store machine-readable instructions, which may be loaded on and executed by the one or more processor 118a-c.

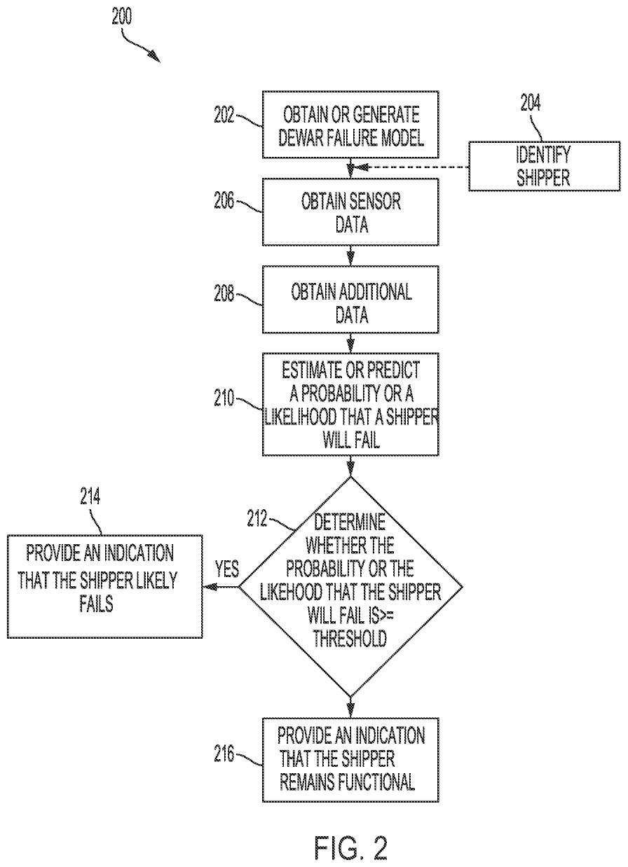

FIG. 2 is a flow diagram of a process 200 for estimating or predicting a probability or a likelihood of a shipper failure. One or more computers or one or more data processing apparatuses, for example, the processor 118b of the failure prediction platform 122 of the failure prediction system 100 of FIG. 1, appropriately programmed, may implement the process 200. The predictive analysis of the failure prediction platform 122 may be performed before the subsequent shipment to determine whether the shipper should go out on delivery. This prevents failures of the shipper 102 during the subsequent shipment, which results in cost savings, higher predictability and increased availability of the shippers. Moreover, the predictive analysis avoids or minimizes the downtime of the shipper 102, improves customer service, avoids late deliveries, optimizes periodic maintenance operations and reduces delivery costs.

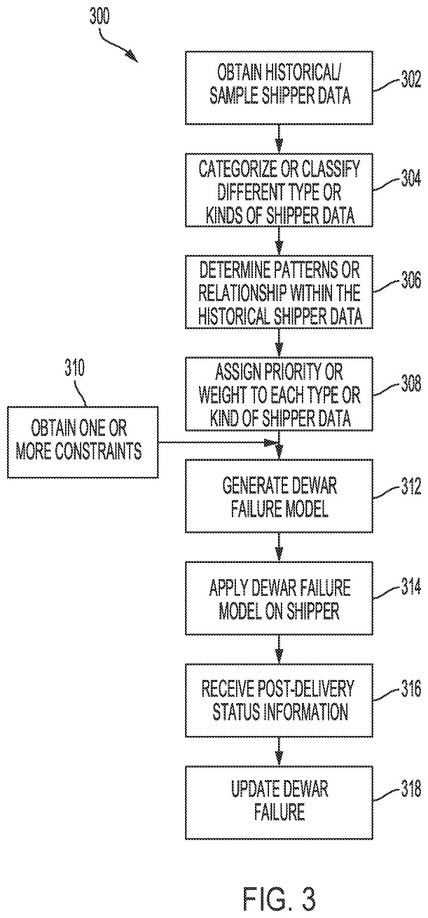

The failure prediction platform 122 obtains or generates a dewar failure model (202). The dewar failure model models a failure of various shippers given one or more constraints, sensor data, historical/sample shipper data, maintenance information or other additional data that may be related to, lead to or cause the potential failure of a shipper 102. The failure prediction platform 122 may use a machine learning algorithm, such as a boosted decision tree algorithm, a neural network and/or a k-nearest neighbor algorithm on the one or more constraints, the input data, such as the sensor data or the historical/sample shipper data gathered from various shipments of various shippers, and their corresponding resulting data that indicates whether the shipment of the shipper failed before, during or after a shipment, to generate the dewar failure model. Once generated, the failure prediction platform 122 may store the dewar failure model in the memory 116b where the failure prediction platform 122 may later access and obtain the dewar failure model to use in estimating or predicting the probability or likelihood that the shipper will fail. The generation of the dewar failure model is further described in FIG. 3 below.

By using multiple sources of data to generate the dewar failure model and perform the estimation and/or prediction of the probability or the likelihood of the potential shipper 102 failure before, after or during the subsequent shipment, the failure prediction platform 122 more accurately performs the estimation and/or prediction and has the capability to account for multiple types of failures, such as a failure that results from poor thermal performance, catastrophic failure and/or mishandling.

The failure prediction platform 122 may identify or determine the shipper 102 that is to be analyzed for potential failure (204). The failure prediction platform 122 may receive user input that indicates the shipper 102 or shippers that are to be analyzed so that the failure prediction platform 122 may tailor the estimation or prediction of the potential shipper failure to the specific shipper 102 or shippers. The user input may indicate identifying information, such as a model, a type, a serial number, a manufacturer, a nitrogen evaporation rate (NER) type or another unique identifier that identifies the shipper 102 or shippers. The failure prediction platform 122 may receive the user input from the monitoring portal 108, such as from the user interface 124, and/or from another user interface of another computing device. In some implementations, the failure prediction platform 122 may detect or obtain an indication of the identifying information, such as the model, the type, the serial number or another unique identifier of the shipper 102, and use the indication to identify the shipper. For example, the shipper 102 may communicate with the failure prediction platform 122 and provide the identifying information to the failure prediction platform 122 and/or one or more sensors may be coupled to the failure prediction platform 122 and scan or otherwise detect the identifying information.

The failure prediction platform 122 may obtain sensor data related to the shipper 102 (206). The one or more sensors 114 on the shipper 102 may collect sensor data related to the potential failure of the shipper 102 before, after and/or during the shipment of the shipper 102 along the designated route of a shipping itinerary. The one or more sensors 114 may include a temperature sensor, a pressure sensor, a shock or vibration sensor or other sensors, such as a GPS device. The temperature sensor may measure the temperature and/or the change in the temperature within the shipper 102 before, during and/or after shipment of the shipper 102. A change in the temperature may indicate a stress that is placed on the shipper 102 as the shipper 102 thermally cycles between different temperatures. The stress may result in potential damage to the shipper 102, which may increase the probability or likelihood that the shipper 102 may fail before, during or after the next shipment of the shipper 102. The change in the temperature may also indicate that the shipper 102 has been damaged and has failed. And thus, the change in the temperature may be indicate of an increase in the probability or the likelihood that the shipper 102 may fail.

The pressure sensor may measure or detect the pressure and/or change in the pressure within the shipper 102, such as the pressure between the inner and outer vessels of a dewar. A change in the pressure may be indicative of a failure or a potential failure within the shipper 102. For example, a drop in the pressure may indicate a leak within the shipper 102. In another example, an increase in the pressure may indicate that there is additional stress against the vessels of the shipper 102, which may lead to a breach in one of the vessels of the shipper 102. The shock or vibration sensor may measure or detect any shocks or vibrations to the shipper 102 before, during or after transit of the shipper 102. The shock or vibration sensor may measure the amount of shock or vibration to the shipper 102. A shock or vibration may indicate that the shipper 102 was impacted by another object before, during and/or after shipment. For example, when the shipper 102 traverses across an uneven roadway the shipper 102 may be jostled against other packages, containers or other surfaces and those other packages, containers or other surfaces may impact the shipper 102, which may damage the shipper 102.

The GPS device may track the amount of distance that the shipper 102 has travelled, the duration that the shipper 102 has been away from the distribution center and/or the routes that the shipper 102 has travelled. The amount of distance, the duration that the shipper 102 has been away from the distribution center and/or the routes that the shipper 102 has travelled may be indicative of the amount of wear and tear to the shipper 102 because the shipper 102 is exposed to an uncontrolled shipping environment. The one or more sensors 114 on the shipper 102 may provide the sensor data to the failure prediction platform 122, which may associate the sensor data to the specific shipper and store the sensor data along with the association in the memory 116a.

The failure prediction platform 122 may obtain additional data related to the shipper 102 (208). The additional data may be user-inputted via the user interface 124. The additional data may include maintenance information, such as the number of thermal cycles that the shipper 102 has undergone, the age of the shipper 102, the mean time between repairs or routine maintenance and/or other information related to the maintenance of the shipper 102, which may affect the lifespan, durability and/or performance of the shipper 102. The additional data may include other data, such as inspection data, the dynamic holding time or other data, which may affect the lifespan, durability and/or performance of the shipper 102. The inspection data may include observations, such as any dents, cracks, fissures or other noticeable damage to the shipper 102. This additional data may contribute to the potential failure of the shipper 102 on a subsequent shipment, and thus, may be used and/or included in the estimation or prediction of the potential shipper failure because the information relates to the reliability and/or sustainability of the shipper 102 to operate.

Once the sensor data and/or the additional data related to the shipper is collected, the failure prediction platform 122 estimates or predicts a probability or a likelihood that the shipper will fail on a subsequent shipment (210). The failure prediction platform 122 may apply the dewar failure model to the sensor data and/or the additional data that is collected or obtained to estimate or predict the probability or the likelihood that the shipper will fail on the subsequent shipment.

In order to estimate or predict the probability or the likelihood that the shipper 102 will fail before, during or after the subsequent shipment, the failure prediction platform 122 may estimate or predict a dynamic holding time of the shipper 102 for a subsequent shipment, which may be based on the previous estimated dynamic holding time of the shipper during the previous shipment. For example, when the dynamic holding time of the shipper 102 is greater than a threshold amount, the dewar failure model may indicate that the failure of the shipper 102 on a subsequent shipment is unlikely and that the shipper 102 will likely maintain its integrity on the subsequent shipment. Whereas, when the dynamic holding time of the shipper 102 is less than the threshold amount, the dewar failure model may indicate that shipper 102 may likely fail on the subsequent shipment, and so, the shipper 102 may need to be replaced.

The dewar failure model may account for all the historical/sample shipper data, sensor data and/or other additional data related to the specific shipper and estimate or calculate the dynamic holding time of the shipper 102 or other characteristic of the shipper 102, such as the stability of the vacuum or temperature within the vessels of the shipper 102. In some implementations, the dewar failure model may account for only the historical/sample shipper data or sensor data that is not highly correlated, e.g., the static and dynamic holding times may be highly correlated with the age of the shipper 102, and thus, only one of the static holding time, the dynamic holding time or the age of the shipper 102 may be used in determining the estimation and/or prediction of the probability or likelihood of the failure of the shipper 102. This may avoid multicollinear behavior that affects the machine learning algorithm.

The dewar failure model may model the characteristic of the shipper 102 by identifying when other shippers, which have had similar characteristics, have failed. The dewar failure model may also model the type of failure that resulted, e.g., whether the dynamic holding time of the shipper was reduced to below a threshold amount, the shipper exhibited some form of observable physical damage to the shipper and/or the vacuum, pressure, or temperature within the shipper was unable to be maintained for a duration of time.

The failure prediction platform 122 may determine whether the probability or the likelihood that the shipper will fail is greater than or equal to a threshold (212). The failure prediction platform 122 may compare the estimated or predicted probability or likelihood to a threshold. The threshold may be a default, pre-determined, user-inputted or otherwise determined threshold. In some implementations, the failure prediction platform 122 may have determined the threshold using the dewar failure model and based on the specific shipper 102 that is being analyzed for whether the shipper 102 would fail.

If the failure prediction platform 122 determines that the probability or the likelihood that the shipper 102 will fail is greater than or equal to the threshold, the failure prediction platform 122 provides an indication that the shipper may likely fail on a subsequent shipment (214). Otherwise, if the failure prediction platform 122 determines that the probability or the likelihood that the shipper 102 will fail is less than the threshold, the failure prediction platform 122 provides an indication that the shipper 102 will likely successfully maintain its integrity and/or remain functional on the subsequent shipment (216).

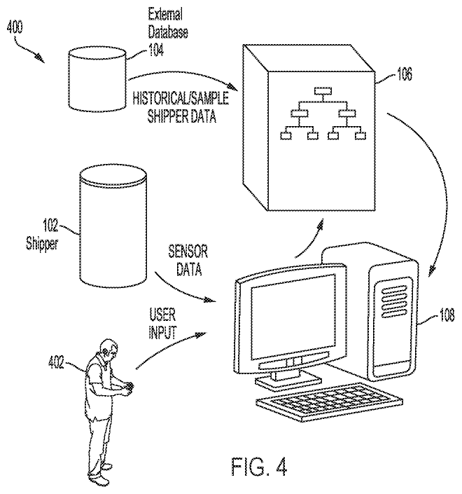

When the failure prediction platform 122 determines that the probability or the likelihood that the shipper 102 will fail is greater than or equal to the threshold, the failure prediction platform 122 provides an indication that the shipper may likely fail on a subsequent shipment (214). The failure prediction platform 122 may provide the indication to the monitoring portal 108 to be displayed on the user interface 124, such as on a display. The indication may be a visual or an audio indicator that indicates that the failure prediction platform 122 anticipates that the shipper 102 would likely fail on the subsequent shipment. The indication may include the estimation or the prediction of the probability or the likelihood of the potential failure of the shipper 102. In some implementations, the indication may also indicate the type or kind of potential failure of the shipper 102. For example, the failure prediction platform 122 may indicate that the potential failure of the shipper 102 may be due to poor thermal performance, catastrophic failure and/or failure due to mishandling. The determination of the type or kind of potential failure of the shipper 102 is further described in FIG. 4 for example.

When the failure prediction platform 122 determines that the probability or the likelihood that the shipper 102 will fail is less than the threshold, the failure prediction platform 122 provides an indication that the shipper 102 will likely be able to successfully maintain its integrity on the subsequent shipment (216). The failure prediction platform 122 may provide the indication to the monitoring portal 108 to be displayed on the user interface 124, such as on a display. The indication may be a visual or an audio indicator that indicates that the failure prediction platform 122 anticipates that the shipper 102 would likely successfully maintain its integrity and/or remain functional before, during and after the subsequent shipment. The indication may include the estimation or the prediction of the probability or the likelihood of the potential failure of the shipper 102.

In some implementations, the failure prediction platform 122 may estimate or predict the probability or the likelihood that the shipper will not fail, e.g., remain functional, on the subsequent shipment instead of or in conjunction with estimating or predicting the likelihood the probability or the likelihood that the shipper 102 will fail. The probability or the likelihood that the shipper 102 will remain functional on the subsequent shipment may be merely the complement of the probability or the likelihood that the shipper 102 will fail on the subsequent shipment.

The failure prediction platform 122 may perform the estimation or the prediction of the probability or the likelihood that the shipper 102 may potentially fail for multiple shippers and output a list of probabilities or likelihoods that each of the shippers may potentially fail. The output may be displayed on the monitoring portal 108 where an operator may review the list to determine whether further testing or review of the shippers may be necessary to determine the viability of the shipper 102 for shipment.

FIG. 3 is a flow diagram of a process 300 for generating and updating the dewar failure model. One or more computers or one or more data processing apparatuses, for example, the processor 118b of the failure prediction platform 122 of the failure prediction system 100 of FIG. 1, appropriately programmed, may implement the process 300.

The failure prediction platform 122 obtains historical/sample shipper data (302). The historical/sample shipper data may have been aggregated, collected or otherwise obtained from previous shipments of various shippers over multiple shipments along different routes. The historical/sample shipper data may include the maintenance information of the various shippers, such as the number of thermal cycles that the shippers have undergone, the duration between maintenance of the shippers, the duration and/or distance that the shipper 102 has traveled, any testing of the various shippers, such as measuring the static/dynamic hold time of the shippers after each shipment, the age of the shippers, observations of any damage of the shippers and/or other information related to the shippers or the shipment of the shippers before, during and/or after previous shipments. The historical/sample shipper data may also include other factors, such as the number of re-pumps that the shipper 102 has undergone, the Nitrogen Evaporation Rate (NER) history, shock events, the LN2 capacity history and/or other contributing factors. The historical/sample shipper data may also include one or more indications of whether the shippers failed before, during or after a subsequent shipment. The historical/sample shipper data may also include the sensor data previously collected from the shippers before, during and after the previous shipments during the lifetime of the shippers and associations between the sensor data that was previously collected from the shippers, the maintenance information of the shipper and the one or more indications of whether the shippers failed before, during or after the subsequent shipment.

The failure prediction system 100 may obtain the historical/sample shipper data from a repository of data stored in the external database 104. The failure prediction system 100 may communicate with the external database 104 via the network 110 to obtain the historical/sample shipper data and use the historical/sample shipper data to generate the dewar failure model, which may be applied to each of the various shippers using a machine learning algorithm.

Once the historical/sample shipper data is obtained for the various shippers, the failure prediction system 100 may categorize or classify the historical/sample shipper data of the various shippers into different types or kinds (304). The failure prediction platform 122 may first segregate the historical/sample shipper data into the various types, kinds or models of the various shippers so that the failure prediction system 100 may determine specific patterns or relationships among the historical/sample shipper data. The failure prediction platform 122 may use the associations to classify/categorize the sensor data, the maintenance information or other data into the specific data for the specific type, kind or model of the shipper 102.

For each of the specific type, kind or model of shipper, the failure prediction platform 122 may determine one or more patterns or relationships within the historical/sample shipper data associated with each specific type, kind or model of the shipper 102 (306). The failure prediction platform 122 may recognize that specific types of data, such as the sensor data associated with the temperature, pressure, dynamic hold time or other data, the maintenance information, such as the number of thermal cycles the shipper 102 has undergone and/or the route information, such as the duration of travel and/or route, or a combination of the specific types of data are more likely to correlate with the failure of the shipper 102 on a subsequent shipment over a period of time.

For example, the failure prediction platform 122 may determine that a specific combination of data, such as a change in the temperature within the shipper 102 and an increase in frequency in usage of the shipper 102, which results in an increased number of thermal cycles over a period of time, may indicate greater wear and tear on the shipper 102, which may increase the probability or the likelihood of the potential failure of the shipper 102 on a subsequent shipment.

In another example, the failure prediction platform 122 may determine another combination of data, such as a change in the pressure within the shipper and regular or constant shocks or vibrations to the shipper, may indicate greater wear and tear in the shipper 102, which may increase the probability or the likelihood of the potential failure of the shipper 102 on a subsequent shipper. Whereas, in another example, the failure prediction platform 122 may determine that frequent maintenance and observational checks of the exterior of the shipper 102 may indicate that the shipper 102 is well maintained, which may decrease the probability or the likelihood of the potential failure of the shipper 102 on the subsequent shipment.

Once the one or more patterns or relationships are determined, the failure prediction platform 122 may assign a priority or weight to the various types or kinds of shipper data (308). The failure prediction platform 122 may assign the priority or weights based on the one or more patterns or relationships defined or determined for the specific shipper 102.

The dewar failure model may assign and/or identify weights that reflect or represent the importance of the specific type of sensor data and/or the type of additional data that relates to the potential failure of the shipper on a subsequent shipment. As a specific type of sensor data and/or the type of additional data more directly corresponds or correlates with the failure of the shipper on a subsequent shipment, the failure prediction platform 122 may assign a greater weight to the specific type of sensor data and/or the type of additional data.

For example, the failure prediction platform 122 may assign a greater priority or greater weight to the types or kinds of shipper data that more directly correlate with the potential failure of the shipper 102 on a subsequent shipment. And, the failure prediction platform 122 may assign a lesser priority or lesser weight to the types or kinds of shipper data that less directly correlates with the potential failure of the shipper on the subsequent shipment. Initially, in some implementations, the failure prediction platform 122 may assign a default, user-inputted or user-configured priority or weight to each type or kind of shipper data to be used by the failure prediction platform 122 to generate the dewar failure model.

The failure prediction platform 122 may obtain one or more constraints (310). The one or more constraints may limit the weight or prioritization of one or more types or kinds of shipper data so that one or more types or kinds of the shipper data do not overly influence or affect the estimation or prediction of the potential failure of the shipper 102. This may normalize or balance the various factors that contribute to the potential failure of the shipper 102 and prevent one type or kind of shipper data related to a parameter that contributes to the potential failure form being over-weighted to a degree such that other factors are not meaningfully reflected in the estimated or predicted probability or likelihood of the potential failure.

The failure prediction platform 122 generates the dewar failure model (312). The failure prediction platform 122 generates the dewar failure model based on the historical/sample shipper data, the one or more constraints and the assigned priority or weights. The dewar failure model may be function of the historical/sample shipper data with the assigned priority or weight while being limited by the one or more constraints. The function may be a machine learning algorithm, such as a boosted decision tree algorithm, that is applied to the historical/sample shipper data with the constrained priority or weight.

Once the dewar failure model is generated, the failure prediction platform 122 may apply the dewar failure model to the shipper for a subsequent shipment (314). The application of the dewar failure model to generate the estimate or predicted probability or likelihood of that the shipper 102 may fail on a subsequent shipment is describe above in FIG. 2 for example. The failure prediction platform 122 may obtain a post-delivery status information that includes whether the shipper 102 failed before, during or after the subsequent shipment (316). The failure prediction platform 122 may receive user input that indicates the post-delivery status information and/or may receive or obtain sensor data from the one or more sensors 114 that indicate the post-delivery status information, such as a failure within the shipper 102. For example, a sensor may detect the loss in a dynamic holding time or other indicator that may indicate the failure of the shipper 102.

The failure prediction platform 122 may update the dewar failure model (318). The failure prediction platform 122 may update the dewar failure model with the post-delivery status information so that the failure prediction platform 122 provides a feedback loop where the dewar failure model is updated in real-time so that the failure prediction platform 122 learns from the accuracy of the previous estimation or prediction. The dewar failure model may be regularly re-trained to continuously improve the accuracy of the dewar failure model. This improves the accuracy and precision of subsequent estimations or predictions performed by the failure prediction platform 122.

The failure prediction platform 122, for example, using the dewar failure model has been tested with historical/sample shipper data to determine the probability of the shipper failure. The results for the high volume shipper indicates that at least approximately 88% of the time the dewar failure model predicted that a specific shipper would fail, the dewar failure model was correct. Moreover, less than approximately 12% of the time the dewar failure model predicted that a specific shipper would fail, the specific shipper did not fail. Additionally, approximately 94% of the time the dewar failure model predicted that a specific shipper would not fail, the dewar failure model was correct. And finally, less than approximately 6% of the time the dewar failure model predicted that a specific shipper would not fail, the shipper 102 did fail.

As far as a standard volume shipper, the failure prediction platform 122 accurately predicted at least approximately 78% of the time that a specific shipper would fail. Moreover, less than approximately 22% of the time the dewar failure model predicted that a specific shipper would fail, the shipper 102 did not fail. Additionally, approximately at least 69% of the time the dewar failure model predicted that a specific shipper would not fail, the dewar failure model was correct. And, finally, less than approximately 31% of the time the dewar failure model predicted that a specific shipper would not fail, the shipper did fail.

FIG. 4 shows a diagram of a summary of the flow of data among the components of the failure prediction system 100 to train and use the dewar failure model to estimate or predict the probability or the likelihood that the shipper 102 would fail before, during or after the subsequent shipment. One or more computers or one or more data processing apparatuses, for example, the processor 118b of the failure prediction platform 122 and/or the processor 118a and the monitoring portal 108 of the failure prediction system 100 of FIG. 1, appropriately programmed, may execute operations to communicate the flow of the data among the components of the failure prediction system 100.

The failure prediction platform 122 may obtain various forms of data related to and/or contributes to the potential failure of the shipper 102. For example, the failure prediction platform 122 may obtain historical/sample shipper data related to various conditions or parameters of multiple shippers that have occurred over multiple shipments from one or more external databases 104 and/or other data repositories. The historical/sample shipper data may include the routes, the number of thermal cycles, the temperature and/or the change in the temperature within the shippers, the pressure and/or the change in pressure, the number of shock events, the orientation of the shippers, the maintenance information of the shippers and/or data, such as static/dynamic holding times or the number of LN2 cycles or re-pumps, related to the condition of the multiple shippers and/or shipments.

The failure prediction platform 122 may also obtain specific data, such as sensor data, related to the specific shipper 102 that is to be analyzed to determine viability for a subsequent shipment in real-time or after a previous shipment. The sensor data may have been collected via one or more sensors 114 and stored in the memory 116a to be later provided to the monitoring portal 108 and/or may be provided to the monitoring portal 108 in real-time where a user 402 may monitor the sensor data. The sensor data may include the temperature, change in temperature, pressure, change in pressure, number or types of shock or vibration events, LN2 capacity and/or other data related to the condition of the shipper 102. The failure prediction platform 122 may also obtain user input that indicates one or more constraints to limit the prioritization or weighting of within the dewar failure model and/or maintenance information related to the condition of the shipper 102. Other user input that may be obtained including the result of the subsequent shipment, e.g., whether the shipper 102 failed or remained functional during the subsequent shipment. The failure prediction platform 122 uses the historical/sample shipper data, the sensor data and the user inputted information to estimate a probability or a likelihood that the shipper 102 may fail on a subsequent shipment and to update and retrain the dewar failure model to improve its accuracy in its estimation or prediction.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A failure prediction system, comprising:
a first sensor configured to detect or measure first sensor data;
a memory configured to store a dewar failure model that models a failure of various shippers given one or more constraints; and
a processor coupled to the memory and the first sensor and configured to:
estimate or predict a probability or a likelihood that a shipper will fail before or during a subsequent shipment of the shipper based on the first sensor data and the dewar failure model, and
provide the estimated probability or likelihood that the shipper will fail before or during the subsequent shipment of the shipper.

2. The failure prediction system of claim 1, further comprising:
a display configured to output the estimated probability or likelihood that the shipper will fail before or during the subsequent shipment of the shipper.

3. The failure prediction system of claim 1, further comprising:
a user interface configured receive user input that indicates whether the shipper failed before, during or after the subsequent shipment of the shipper;
wherein the processor is configured to:
update the dewar failure model based on the user input and the sensor data in real-time.

4. The failure prediction system of claim 1, wherein the sensor includes at least one of a temperature sensor, a shock or vibration sensor, or a pressure sensor and the sensor data includes at least one of a temperature within the shipper, shocks or vibrations to the shipper or a pressure within the shipper.

5. The failure prediction system of claim 1, wherein the processor is further configured to estimate or predict the probability or the likelihood that the shipper will fail before or during a subsequent shipment of the shipper using a machine learning algorithm.

6. The failure prediction system of claim 5, wherein the machine learning algorithm is a boosted decision tree algorithm.

7. The failure prediction system of claim 1, wherein to estimate or predict the probability or the likelihood that the shipper will fail before or during the subsequent shipment of the shipper the processor is configured to estimate or predict a probability or a likelihood that a dynamic holding time of the shipper is less than a threshold amount.

8. The failure prediction system of claim 1, further comprising:
a second sensor configured to measure or detect second sensor data, wherein the first sensor is a temperature sensor and the first sensor data is a temperature within the shipper and the second sensor is a pressure sensor and the second sensor data is a pressure within the shipper.

9. The failure prediction system of claim 1, wherein the processor is configured to:
obtain user input that indicates a type, model or identifier of the shipper;
obtain maintenance information related to the type, model or the identifier of the shipper; and
estimate or predict the probability or the likelihood that the shipper will fail before or during the subsequent shipment of the shipper further based on the maintenance information and the user input.

10. The failure prediction system of claim 9, wherein the maintenance information includes a number of thermal or temperature cycles that the shipper has undergone.

11. A failure prediction system, comprising:
a processor configured to:
obtain at least one of maintenance information or sensor data,
estimate or predict a probability or a likelihood that a shipper will fail before or during a subsequent shipment of the shipper based on the at least one of the maintenance information or the sensor data and using a machine learning algorithm, and
provide to a user the estimated probability or likelihood that the shipper will fail before or during the subsequent shipment of the shipper; and
a display configured to output to the user the estimated probability or likelihood that the shipper will fail before or during the subsequent shipment of the shipper.

12. The failure prediction system of claim 11, further comprising:
a memory configured to store a dewar failure model;
wherein the processor is configured to estimate or predict the probability or the likelihood that the shipper will fail before or during the subsequent shipment of the shipper further based on the dewar failure model.

13. The failure prediction system of claim 12, further comprising:
a user interface configured receive user input that indicates whether the shipper failed before during the subsequent shipment of the shipper;
wherein the processor is configured to:
update the dewar failure model based on the user input in real-time and the at least one of the maintenance information or the sensor data in real-time.

14. The failure prediction system of claim 11, further comprising:
a sensor configured to measure or detect the sensor data, wherein the sensor includes at least one of a temperature sensor, a shock or vibration sensor, or a pressure sensor and the sensor data includes at least one of a temperature within the shipper, shocks or vibrations to the shipper or a pressure within the shipper.

15. The failure prediction system of claim 14, wherein the processor is further configured to estimate or predict the probability or the likelihood that the shipper will fail before or during a subsequent shipment of the shipper using a machine learning algorithm.

16. The failure prediction system of claim 11, wherein the machine learning algorithm is a boosted decision tree algorithm.

17. The failure prediction system of claim 11, wherein to estimate or predict the probability or the likelihood that the shipper will fail before or during the subsequent shipment of the shipper the processor is configured to estimate or predict a probability or a likelihood that a dynamic holding time of the shipper is less than a threshold amount.

18. The failure prediction system of claim 11, wherein the processor is configured to:
obtain user input that indicates a type, model or identifier of the shipper; and
estimate or predict the probability or the likelihood that the shipper will fail before or during the subsequent shipment of the shipper further based on the user input.

19. The failure prediction system of claim 11, wherein the maintenance information includes a number of thermal or temperature cycles that the shipper has undergone.

20. A method for predicting failure of a shipper, comprising:
obtaining, by a processor, a dewar failure model that models a failure of various shippers;
detecting or measuring, by a sensor, sensor data that relates to a failure of the shipper;
estimating or predicting, by the processor, a probability or a likelihood that the shipper will fail before or during a subsequent shipment of the shipper based on the sensor data and the dewar failure model; and
displaying, by the processor and on a display, the estimated probability or likelihood that the shipper will fail before or during the subsequent shipment of the shipper.
